(19) United States
(12) Patent Application Publication
(10) Pub. No.: US 2020/0383851 A1
(43) Pub. Date: Dec. 10, 2020

(54) NURSING BED

(71) Applicant: Hans-Joachim KLEEBERG, Erlangen (DE)

(72) Inventor: Hans-Joachim KLEEBERG, Erlangen (DE)

(21) Appl. No.: 16/628,634

(22) PCT Filed: Jun. 14, 2018
(86) PCT No.: PCT/EP2018/065829

§ 371 Date: Mar. 13, 2020

(30) Foreign Application Priority Data
Jul. 5, 2017 (DE) 10 2017 115 031.5

(51) Int. Cl. A61G 7/015; A61G 7/057; A61G 7/012

(52) U.S. Cl. CPC A61G 7/015; A61G 7/012; A61G 7/0573

(57) ABSTRACT

The invention relates to a nursing bed (10) comprising a first frame (34) which supports a first mattress part (18a). The first frame (34) has a central section (40), a back section (44) and an upper leg section (46) and a lower leg section (47). The nursing bed (10) also comprises a second frame (35) having a foot section (57), wherein the second frame (35) supports a second mattress part (18b). The first frame (34) and the second frame (35) of the nursing bed (10) according to the invention are supported by a base (20) of the nursing bed (10). In a nursing bed according to the invention, the second frame (35) is supported separately from the first frame (34) on the base (20). The nursing bed (10) according to the invention is characterised, in particular, in that the second frame (35) being supported separately from the first frame (34) by the base (20) is height-adjustable relative to the base (20). When the vertical position of the second frame (35) relative to the base (20) and/or relative to the central section (40) can be adapted to the position of the lower leg section (47), the nursing bed (10) can be adjusted such that the heels of the patient are supported by the second mattress part (18b) on the foot section (57), and thereby supported by the second frame (35), when the lower leg section (47) is arranged in a position for elevating the legs of the patient. This leads to relief for the patient and to an improvement in leg elevation for therapeutic and preventative purposes.

### CROSS REFERENCE TO RELATED APPLICATIONS

This application is a National Stage of PCT Application No. PCT/EP2018/065829 filed on Jun. 14, 2018, which claims priority to German Application No. 10 2017 115 031.5 filed on Jul. 5, 2017, the contents each of which are incorporated herein by reference thereto.

### TECHNICAL FIELD

The invention refers to a nursing bed.

### BACKGROUND

Nursing beds that comprise a first frame supporting a first mattress part, wherein the first frame comprises a central section, a back section and a leg section are known from the prior art DE 10 2009 049 279 A1, DE 10 2007 014 101 A1 or U.S. Pat. No. 5,497,518 B1. The beds also comprise a base that carries the first frame. In addition, the nursing beds comprise a second frame with a foot section that is arranged at the foot end of the nursing bed. The second frame supports the second mattress part. The first frame of known nursing beds, compare also DE 10 2009 025 285 A1, can be transferred from a horizontal flat lying position, in which the first frame provides a flat mattress support surface from the head end of the bed to the foot side end of the first frame, into a position in which the foot section of the first frame is arranged in a lifted position relative to the base with reference to the position of the foot section in the flat lying position. The second frame, however, is rigid and non-moveably attached to the base.

The adjustability of the first frame can be used particularly for raised placement of the legs of the patient relative to its pelvis for therapeutic or preventive reasons.

### BRIEF SUMMARY

Starting from the indicated prior art it is the object of the invention to provide an improved nursing bed.

Disclosed is a nursing bed including: a base; a first frame that supports a first mattress part, wherein the first frame comprises a central section, a back section and a thigh section as well as a lower leg section; a second frame with a foot section, wherein the second frame supports a second mattress part; wherein the first frame and the second frame are supported by the base; wherein the second frame is supported separately from the first frame at the base; and wherein the second frame is height adjustable relative to the base.

The nursing bed comprises a base that supports an adjustable first frame and a second frame of the nursing bed. The first frame comprises a central section, a back section and a thigh section as well as a lower leg section. The first frame supports a first mattress part for the torso and the legs of the patient. The second frame comprises a foot section and supports a second mattress part for the feet of the patient. The second frame is supported separately from the first frame at the base. The second frame is height adjustable relative to the base, particularly relative to the upper side thereof. The second frame is more preferably height adjustable separately from the first frame. The first mattress part and the second mattress part are preferably mattress parts separate from each other.

The second frame and the first frame are preferably separated from each other. Particularly, the second frame is preferably not hinged to the first frame, preferably at least not at the lower leg section of the first frame.

Due to the height adjustability of the second frame with the foot section that supports a second mattress part for resting the feet of the patient, the position of the second frame relative to the base of the nursing bed according to the invention can be adjusted such that the second mattress part supports the feet of the patient at least partly, even though the lower leg section is arranged in a position for therapeutic or preventive raised leg placement. Preferably, the height of the support surface of the second frame for supporting the mattress can be adjusted relative to the base for adaption after and/or during the vertical position of the support surface of the lower leg section for supporting the mattress is adjusted upward relative to the base for example for raised leg placement.

With the height adjustable foot section that can preferably follow the lower leg section it can be avoided for example that the lower leg rests on an foot side edge of the second frame (lower edge of the lower leg part) and the feet extend beyond the edge, because the weight of the lower leg is supported via the heel that rests on the mattress part of the foot section is at least partly supported by the foot section in a position of the lower leg section for preventive or therapeutic raised leg placement. In doing so, the decubitus creation in the lower leg region at the rest edge of the lower leg part can be prevented. In addition, the abdominal muscles are relieved from the reflex tension that is initiated due to the stretch from the lower leg and the foot. If the feet do not hang in the air but the heel rests on the mattress part that is supported by the foot section, the feet can be covered and thus remain warm.

With the height adjustable second frame and thus the height adjustable foot section of the lying surface, the acceptance of the raised leg placement is improved and duration or frequency of the applicability of the raised leg placement can be increased, because during the raised leg placement problems that potentially exist in known beds do not occur in the application of the inventive nursing bed. In doing so, the effectiveness of the preventive or therapeutic raised leg placement can be increased with the inventive nursing bed. If the nursing bed is configured for adjustment of different positions of the foot section relative to the lower leg section, pressure relieves of the heel area and the lower leg area can be selectively adjusted.

The therapeutic or preventive raised leg placement stimulates the venous back-flow of the blood. In addition, the raised leg placement can stimulate the lymphatic drainage. In addition, the raised leg placement results in a relaxation of the abdominal wall. Finally, the raised leg position results in a prophylaxis of deep leg vein thromboses and thus of pulmonary embolisms. Also the temporary raised leg placement can prevent decubitus ulcers in the leg as well as in the heel area. Because the therapeutic or preventive raised leg placement is executed more frequently and/or longer as in known nursing beds, the therapeutic or preventive effectiveness of the inventive nursing bed is increased with regard to known nursing beds.

The first frame of the nursing bed is preferably adjustable such that a first frame can be brought into a seat position, also named as chair position. In the seat position, the first frame is preferably turned around a preferably vertical height axis (preferably about 90°) relative to the horizontal flat lying position, in which the first frame extends along the longest side along the longitudinal axis of the bed, such that the patient sits in the chair formed by the first frame and the mattress part of the first frame orientated transverse to the longitudinal axis of the bed in the seat position. In the seat position, the back section is preferably straight. The lower leg section is preferably arranged in a downward folded manner outside the bed outer frame in the seat position. The patient sits in the seat position with his/her legs over the edge of the bed outer frame. In the seat position, the feet of the patient extend preferably over the lower edge of the mattress part that is supported by the first frame in the direction toward the ground. Preferably, the lower edge of the mattress part is distant from the ground in the seat position.

Preferably the lower leg section of the second frame is separately height adjustable from the second frame. Thus, the lower leg section can be raised above the second frame, for example for initiating the movement of the first frame in a seat position, without the need to concurrently lower the second frame such that the lower leg section can be pivoted over the second frame during rotation of the first frame about the height axis for achieving the seat position. Alternatively or additionally, the second frame is preferably height adjustable relative to the base separately from the lower leg section, such that the distance of the lower leg section from the base can remain unchanged during a height adjustment of the second frame relative to the base.

The second frame is preferably torque proof attached at the base with regard to rotations about the height axis, particularly the second frame preferably does not participate at a rotation movement of the first frame about the height axis.

In order to simplify the nursing of a patient and/or in order to assist a patient in getting up from the seat position, the base is preferably height adjustable.

The nursing bed is preferably configured such that the second frame is moved concurrently with regard to the horizontal direction towards the head end of the nursing bed during the height adjustment upward relative to the base. The second frame can be moved along a straight line that is orientated inclined to the vertical and/or along arcuate path, for example a curve, during an upward height adjustment. The nursing bed can be configured for the height adjustment of the second frame, for example by a mechanical guide element and/or by a respective control of the drive or the drives.

Particularly preferably the nursing that is configured to adjust the second frame in the height such that the distance of the second frame to the lower leg section is maintained during the height adjustment of the lower leg section. The maintenance of the distance includes changes of the distance during the height adjustment of ±10%. Preferably, the height adjustment of the second frame is carried out such that the distance of the second frame to the lower leg section of the first frame remains constant during the height adjustment of the lower leg section. If the nursing bed is configured to adapt the position of the second frame due to the height adjustment of the position of the lower leg section during the height adjustment of the lower leg section, the comfort for the patient lying in the nursing bed can be increased. Particularly, no gap is created between the first frame and the second frame such that the patient could get cold due to the gap if the distance of the second frame to the lower leg section is maintained during a change of the position of the lower leg section by respective height adjustment of the second frame. If between the first frame and the second frame also a gap exists in the horizontal flat lying position, the gap is preferably increased during an adaption at most in a way that the distance between the first frame and the second frame is increased about 10% at most or the distance remains constant. If the movement of the second frame follows the movement of the lower leg section in addition, a pushing or pulling of the heel of the foot of the patient over the second mattress part can be mitigated or largely avoided during the height adjustment which increases the comfort for the patient lying in the nursing bed.

The nursing bed is preferably configured to maintain the angle included between the mattress support surface of the lower leg section of the first frame and the mattress support surface of the foot section of the second frame during the height adjustment of the second frame. The maintenance of the angle during a height adjustment includes a change of the angle in the range of ±10%. Particularly preferably the angle remains constant during a height adjustment.

The nursing bed is preferably configured such that the second frame can be lowered relative to the lower leg section of the first frame. For example, the second frame can be lowered by a respective device for control of the nursing bed relative to the lower leg section, while the first frame or at least its lower leg section remains in its position. For example, the second frame can be lowered if the first frame is in the horizontal flat lying position and/or if the lower leg section is in a position for raised leg placement. Due to a lowering of the second frame relative to the lower leg section, the heel of the foot of the patient can be relieved. The nursing bed is preferably configured for lowering the second frame relative to the lower leg section such that in the lowered position, the heels of the feet of the patient still rest on the mattress part that is supported by the foot section of the second frame.

The nursing bed is preferably configured to lower the second frame relative to the lower leg section for preparing an adjustment or during an adjustment of the first frame from the flat lying position in the seat position, from a position of the lower leg section for raised leg placement in the seat position and/or from a seat position in the flat lying position or the position for raised leg placement.

The nursing bed preferably comprises a first drive that is assigned to the first frame for adjustment of the first frame or at least for adjustment of the height and/or the inclination of the lower leg section of the first frame and the nursing bed preferably comprises a second drive that is assigned to the second frame for height adjustment of the second frame, wherein the first drive and the second drive are separate drives.

The drive for the second frame is preferably arranged on one side of a virtual vertical plane that is arranged between the first frame and the second frame, wherein the first frame is arranged on the other side of the plane.

The nursing bed preferably comprises at least two telescopic guides for guiding the second frame for the height adjustment relative to the base and preferably at least a linear drive for driving the second frame for the height adjustment.

Additional preferred features of the inventive nursing bed can be derived from the dependent claims, the following description as well as the figures.

### BRIEF DESCRIPTION OF THE DRAWINGS

FIGS. 1-3 illustrate a nursing bed according to the prior art,

FIG. 4a illustrates an arrangement for an inventive nursing bed according to a first exemplary embodiment,

FIG. 4b is an illustration in part of the arrangement shown in FIG. 4a,

FIGS. 5 and 6 are views of the arrangement shown in FIGS. 4a, 4b for the inventive nursing bed according to the first exemplary embodiment,

FIGS. 7, 8, 9 are views of an arrangement for an inventive nursing bed according to a second exemplary embodiment, and

FIGS. 10, 11 and 12 are views of an arrangement for an inventive nursing bed according to a third exemplary embodiment.

### DETAILED DESCRIPTION

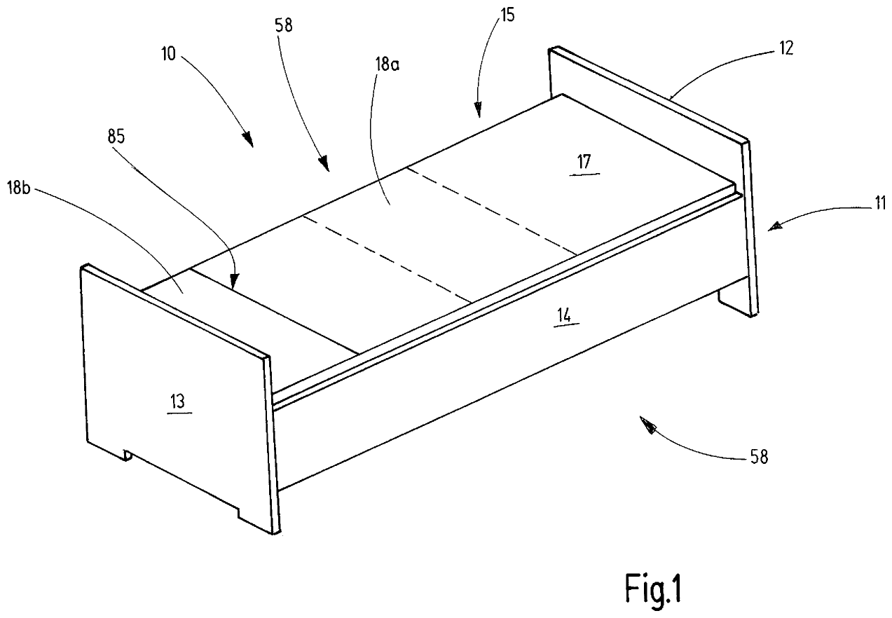

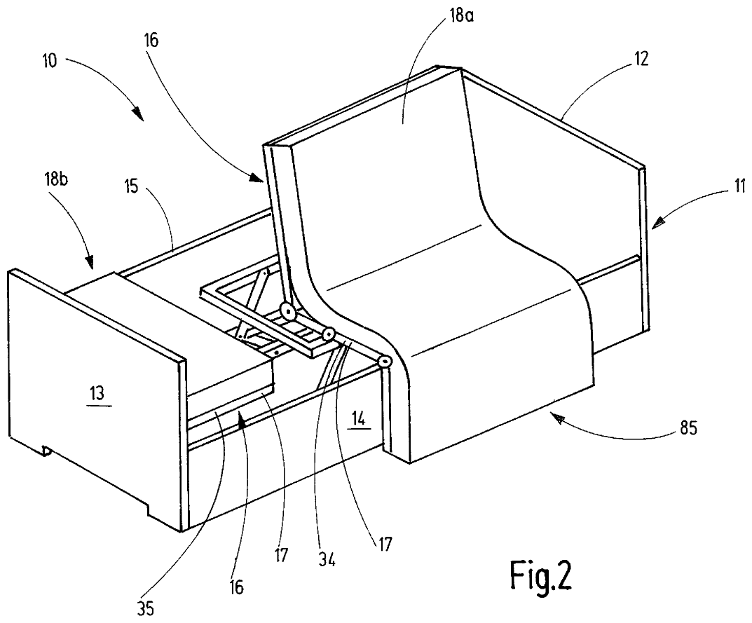

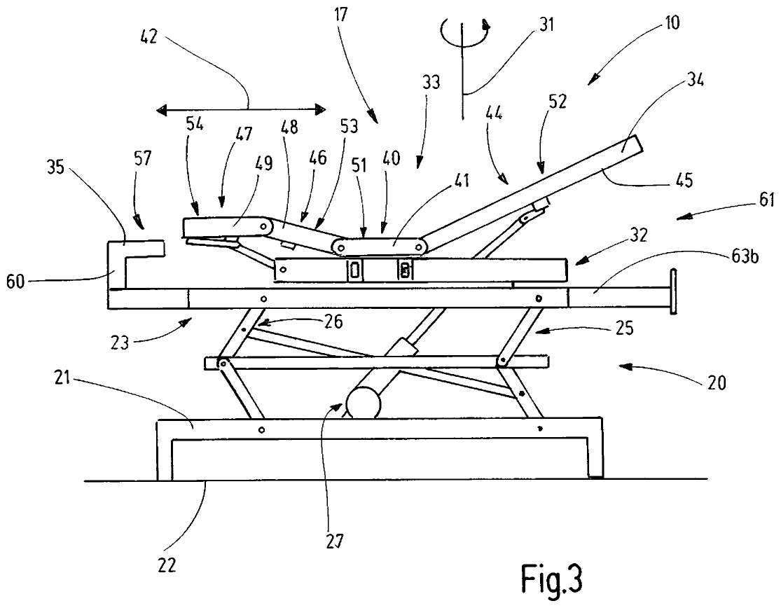

FIG. 1 shows a nursing bed according to the prior art of DE 10 2007 014 101 A1 with a bed outer frame 11 with a head part 12, a foot part 13 and side walls 14, 15. Within the bed outer frame 11, a bedstead 16 is arranged that provides support surface 17 (see FIGS. 2, 3) for a mattress 18. In the embodiment illustrated in FIG. 1, the bedstead 16 assumes a flat lying position such that the mattress 18 supported by the bedstead 16 provides a flat lying surface for the patient extending from the head part 12 to the foot part 13 in the flat lying position.

FIG. 3 shows a bedstead 16 of the prior art of DE 10 2007 014 101 A1 that is arranged within the bed outer frame 11. The bedstead 16 comprises a height adjustable base 20 with a lower frame 21 (bed foot) that rests on the ground 22 and an upper frame 23 that is supported by the lower frame 21, wherein the vertical position of the upper frame 23 is adjustable relative to the lower frame 21 of the base 20 or relative to the ground 22. For height adjustment of the base 20, components such as toggle lever pairs 25, 26 between the lower frame and the upper frame and a lift motor 27 are present, the arrangement and cooperation of which for the height adjustment is described in detail in DE 10 2007 014 101 A1.

A swivel joint is attached on the upper frame 23 of the base that defines a preferably vertical height axis 31 (rotation axis). The swivel joint is arranged within the upper frame 23 and is thus not visible in the rotation position of FIG. 3. On the swivel joint, an intermediate frame 32 is rotatably arranged about the height axis 31.

A lying frame 32 is arranged on the upper frame 23 of the base 20 that is separated in a first frame 34 and a second frame 35. The first frame 34 is supported by the intermediate frame 32. The first frame 34 comprises a central section 40 via which the first frame 34 is attached to the intermediate frame 32 such that the first frame 34 participates at a rotation movement of the intermediate frame above the height axis 31. The central section 40 comprises two longitudinal struts 41 that extend along the longitudinal direction 42 of the nursing bed 10 in the position shown in FIG. 3 and in the flat lying position. In relation to the intermediate frame 32 the central section 40 is preferably non-moveably attached at the intermediate frame 32. A back section 44 of the first frame 34 is hinged to the central section 32 such that an inclined position of the back section 44 relative to the central section 40 or relative to the upper frame 23 of the base is possible. The back section 44 also comprises two longitudinal struts 45. A thigh section 46 of the first frame 34 is hinged at the opposite end of the central section 40, wherein a lower leg section 47 of the first frame 34 is hinged in turn to the end of the thigh section. The thigh section 46 and the lower leg section 47 each comprise two longitudinal struts 48, 49. Due to the illustration, only one of the longitudinal struts 41, 45, 48, 49 of the sections 40, 44, 46, 47 of the first frame 34 is visible respectively. The lower leg section 47 comprises at least one transverse strap 50 via which the longitudinal struts 48 of the lower leg section 47 are connected with each other. The transverse struts are not visible in the illustration according to FIG. 3. The longitudinal struts of each additional section 44, 45, 46 of the first frame 34 are also connected via transverse struts.

The nursing bed is configured such that the lower leg section 47 of the first frame 34 can be brought in a position for raised leg placement in which the lower leg section 47 is raised relative to the central section 40 and—in addition—the thigh section 46 is inclined relative to the horizontal (compare FIG. 3) compared with the horizontal flat lying position (FIG. 1), in which the mattress support surface 51 of the central section 40, the mattress support surface 52 of the back section 44 as well as the mattress support surface 53 of the thigh section 46 and the mattress support surface 54 of the lower leg section 47 are lying horizontally. The mattress support surfaces 51, 52, 53, 54 form contact surfaces for supporting of the mattress. The first frame 34 carries a first mattress part 18a for the torso, the bottom as well as the thighs and the lower legs of the patient. The second frame 35 supports a second mattress part 18 b for the feet of the patient that is separated from the first mattress part 18a. In the position of the raised leg placement, the mattress support surface 54 of the lower leg section 47 for supporting the second mattress part 18b can be arranged for example horizontally. In FIG. 3, the back section 44 is inclined in addition.

A mechanism for lifting the lower leg section 47 and the thigh section 46 by means of a drive with the lift motor 27 is, for example, described in DE 10 2009 025 285 A1. The mechanism of the nursing bed 10 illustrated in FIG. 3 can be designed and configured in the same manner.

The second frame 35 of the lying frame 33 of the bedstead 16 according to FIG. 3 comprises a foot section 57 that supports the second mattress part (foot part) 18b of the mattress 18. The second frame 35 is fixedly attached at the upper frame 23 of the base 20.

The nursing bed 10 according to FIG. 3 is configured to bring the first frame 34 in a seat position that can also be named as chair position. In FIG. 2, the nursing bed 10 is illustrated in the chair position. In the chair position, the first frame 34 is arranged in an orientation transverse to the longitudinal sides 58 of the nursing bed 10. The first frame 34 reaches this orientation by rotation of the first frame 34 about the height axis 31 about 90° as well as by adjustment of the back section 44, the thigh section 46 and the lower leg section 47. In the chair position, the lower leg section 47 is arranged outside the bed outer frame 11 and is folded downward. The back section 44 is preferably straight. Taking the chair position facilitates or allows the patient to exit the nursing bed 10.

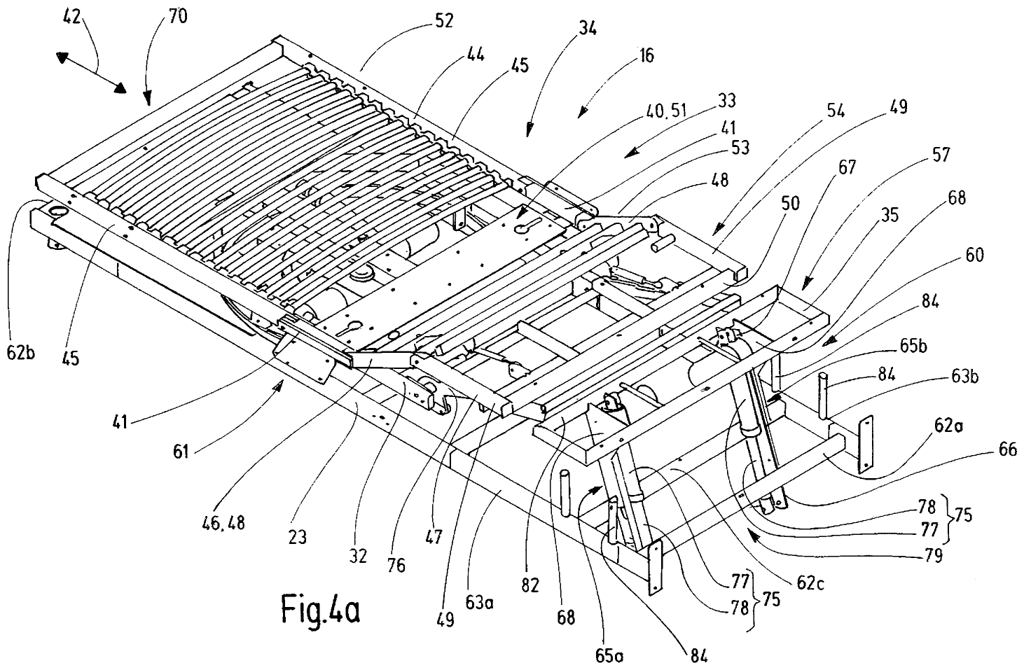

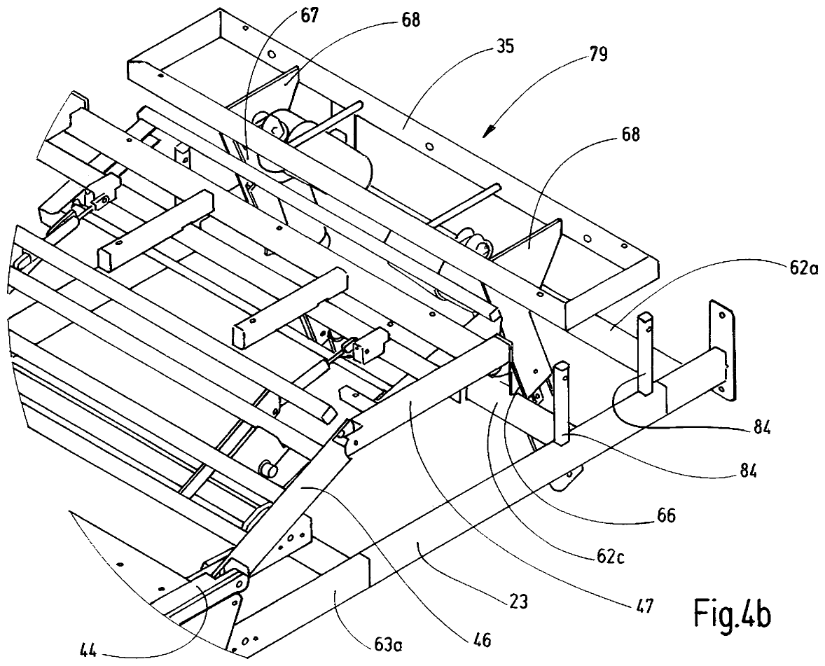

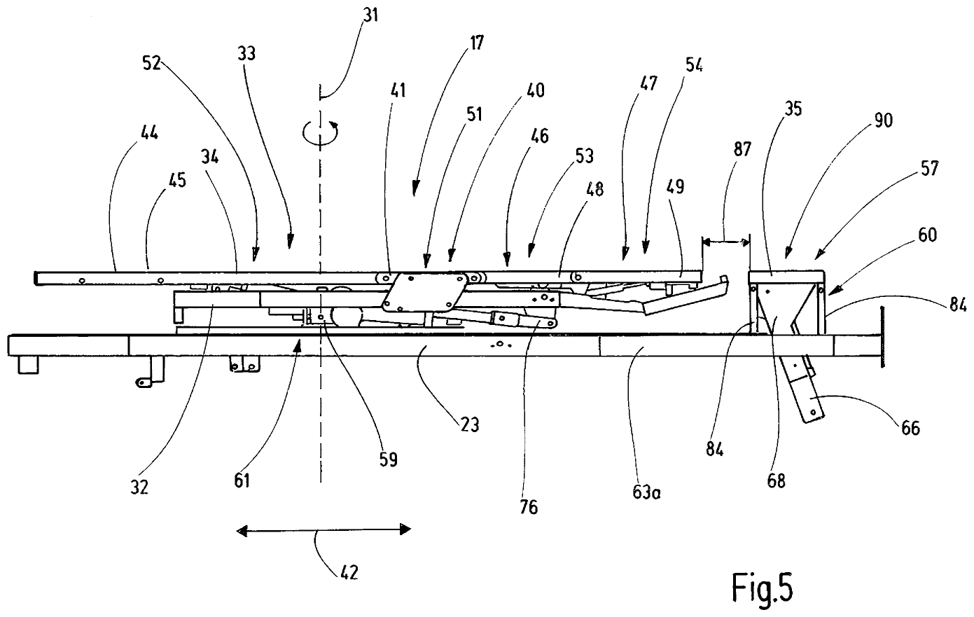

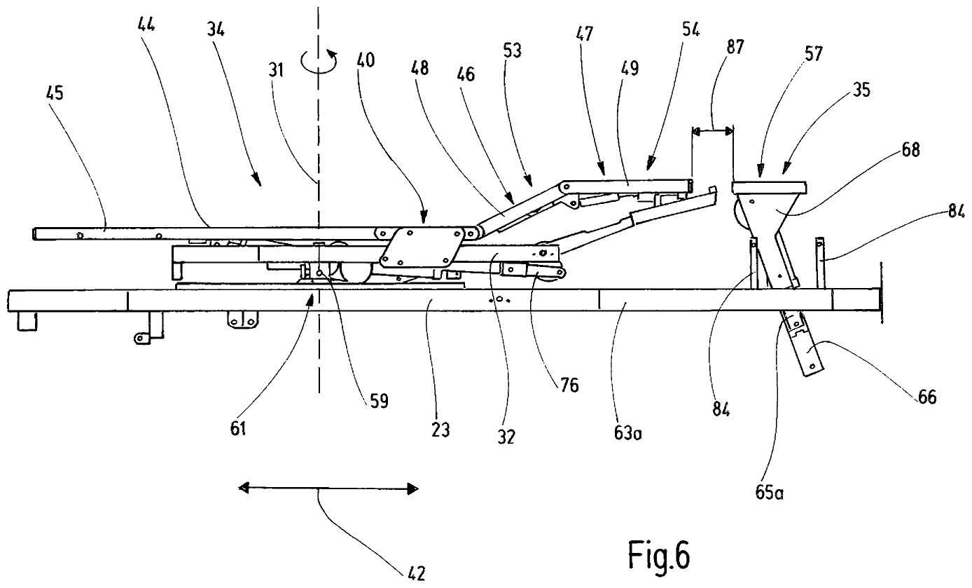

FIG. 4a shows the upper frame 23 of the base 20 as well as the lying frame 33 of an exemplary embodiment of an inventive nursing bed 10. The mechanical configuration of the base 20, the swivel joint 59 (compare FIGS. 5 and 6), the intermediate frame 32 as well as the first frame 34 of the inventive nursing bed 10 and their cooperation can be similar to the configuration and the cooperation of the nursing bed 10 described with reference to FIGS. 1-3. The inventive nursing bed 10 preferably comprises particularly the adjustment possibilities described in connection with FIGS. 1-3. The arrangement illustrated in FIG. 4a with the upper frame 23 as well as the devices arranged thereon such as the lying frame 33, can be put with the upper frame 23 with the devices of the nursing bed 10 placed thereon onto the lower frame 21 as shown in FIG. 3 instead of the respective arrangement. The foregoing description with regard to FIGS. 1, 2, 3 can be accordingly used for the figures that show the arrangements for the inventive nursing bed. Different to the nursing bed 10 according to FIGS. 1-3 of the prior art, the vertical position of the second frame 35 in the inventive nursing bed 10 is, however, changeable relative to the upper frame 23 of the base 20 or relative to the central section 40 of the lying frame 34 of the nursing bed 10.

The second frame 35 is supported at the upper frame 23 of the base 20 separately from the first frame 34. In the embodiment, the second frame 35 is supported by a second support device 60 at the upper frame 23 of the base 20 in lifted positions and in the position for the flat lying position that is separate from the first support device 61 with which the first frame 34 is supported at the upper frame 23. The first support device 61 comprises the intermediate frame 32 and the swivel joint 59. At the foot end of the upper frame 23 of the base 20 of the embodiment of the inventive nursing bed 10 according to FIG. 4, however, an additional transverse strap 62c is attached between the longitudinal struts 63a, b of the upper frame 23 between the outermost transverse struts 62a, b of the upper frame 23. At the additional transverse strut 62c two telescopic guides 65a, b are arranged between the longitudinal struts 63a, b. Each telescopic guide 65a, b comprises a first guide part 66 that is attached to the additional transverse strut 62c and is supported at the additional transverse strut 62c (see FIG. 4b). Each telescopic guide 65a, b comprises a second guide part 67 that is moveably guided along a straight line in telescopic manner at the first guide part 66 relative to the first guide part 66 of the telescopic guide 65a, b. The second guide parts 67 are fixedly attached at fastening sections 68 of the second frame 35. The telescopic guides 65a, b are arranged inclined to the vertical such that the second frame 35 is moved concurrently in relation to the horizontal direction relative to the upper frame 23 during an upward movement. The telescopic guides 65a, b are particularly inclined toward the head end 70 of the nursing bed 10 such that the second frame 35 concurrently moves in direction toward the head end 70 of the nursing bed during lifting of the second frame 35 relative to the upper frame 23 of the base 20 or relative to the central section 40.

In the illustrated embodiment of the inventive nursing bed 10 the second frame 35 is driven with two linear drives 75 for height adjustment that are drives 75 separate from the drive unit 76 for the height adjustment of the lower leg section 47. The linear drives 55 each comprise a first part 77 that can be driven for straight linear movement relative to a second part 78 of the linear drive 75. The first parts 77 of the linear drives 75 are each articulately attached at the transverse strut 82 of the second frame 35 positioned away from the foot end 79 of the nursing bed 10. The second part 78 of the linear drives 75 are each connected with the first guide part 66 of the adjacent telescopic guides 65a, b such that the second parts 78 of the linear drive 75 are supported via the first guide part 66 of the telescopic guide 65a, b at the transverse strut 62c and thus at the upper frame 23. The movement direction of the first part 77 relative to the second part 78 of each linear drive 75 is preferably parallel to the guide direction of the telescopic guides 65a, b. At least one of the linear drives 75, preferably both linear drives 75, are preferably self-locking such that the linear drives 75 can be switched in a zero-current condition without the need to lock the position of the second frame 35 with devices separate from the linear drives 75 for locking of the movement of the second frame 35 along the guide direction. Each of the linear drives 75 can be an electromechanical linear drive 75 the electric motor of which drives a spindle in order to linearly move a spindle nut.

With the telescopic guides 65a, b, the moving possibilities of the second frame 35 are limited to movements along a vertical plane that extends along the longitudinal sides 58 of the nursing bed 10. Particularly, the second frame 35 does not participate at a rotation movement of the first frame 34 about the rotation axis 31 for reaching the chair position of the first frame 34. Rather the second frame 35 remains preferably always within the bed outer frame 11.

In the embodiment illustrated in FIGS. 4a, b, 5, 6, the linear drive 75 and the guides 65a, b for the height adjustment are particularly in the lowest position of the second frame 35 or in the position for the flat lying position of the nursing bed 10 arranged below the second frame 35. The embodiment according to FIG. 4a, 4b, 5, 6, is an embodiment of the inventive nursing bed 10 in which the drive 75 for the height adjustment of the second frame 35 are arranged such that between the first frame 34 and the second frame 35 a plane can be virtually arranged that intersects the space in two parts wherein the drives 75 for the height adjustment of the second frame 35 are arranged in one space half (that is on one side of the plane) and the first frame 34 and preferably also the drive 76 for the height adjustment of the position of the lower leg section 47 relative to the upper frame 23 of the base 20 is arranged in the other space half (on the other side of the plane). Alternatively or additionally, the support device 60 for supporting the second frame 35 is arranged in the one space half and the device for supporting the first frame 34 and/or the first frame 34 is arranged in the other space half. The mentioned vertical plane can be virtually arranged in this manner particularly in the flat lying position of the first frame 34 and the second frame 35. With the spatially separation mechanical retrofit work for mounting of a setup change set for an existing nursing bed 10 for retro fitting the height adjustable second frame 35 in the nursing bed 10 remain preferably limited to the foot end 79 of the nursing bed 10.

On each of the longitudinal struts 63a, b of the upper frame 23 of the base, two stands 84 are arranged on which the second frame 35 can be lowered. The stands 84 can support the second frame 35 in a position of the second frame 35 and define vertical lower end positions of the second frame 35.

Alternatively to separate drives 75, 76 for the adjustment of the lower leg section 47 and the second frame 35, the nursing bed 10 can be configured for changing of the vertical position of the second frame 35, for example by a mechanic coupling of the drive 76 for the height adjustment of the lower leg section 47 with the second frame 35. Such a coupling can be established in an embodiment of the adjustment of the vertical position of the second frame 35 and can subsequently be suspended again. However, preferably the second frame 35 and the drive unit 76 for the height adjustment of the lower leg section 47 relative to the base are always decoupled.

Preferably, the inventive nursing bed 10 comprises a control unit (not shown) for controlling of the drive 75, 76 for adjustment of the first frame and the second frame.

A range of positions is defined for the nursing bed 10 into which the lower leg section 47 can be brought for therapeutic or preventive raised leg placement, wherein one position is characterized by a vertical position of the lower leg section 47 relative to the upper frame 23 of the base 20. In each position of the range, the longitudinal struts 41 of the central section 40 extend along the longitudinal direction 42 of the nursing bed (rotation position of the central section 40 and the first frame 34 as in the flat lying position (FIG. 1)). Accordingly, the lying surface is orientated along the longitudinal direction 42 of the nursing bed 10 in each position of the range. The range comprises preferably at least positions of the lower leg section 47 for therapeutic or preventive raised leg placement in which the mattress support surface 54 of that lower leg section 47 is horizontal or tilted up to 10 degrees relative to the horizontal toward the foot end 79 or toward the head end 70 of the nursing bed 10. The range comprises preferably at least all positions of the lower leg section 47 for therapeutic or preventive raised leg placement in which the nursing bed 10 is configured to transfer the lower leg section 47 and in which the mattress support surface 54 of the lower leg section 47 is horizontal or up to 10 degrees tilted relative to the horizontal toward the foot end 79 or toward the head end 70. In each of the positions of the range, the lower leg section 47 is lifted relative to the flat lying position of the first frame 34. The flat lying position of the nursing bed 10 according to FIGS. 4a, 4b is shown in FIG. 5. FIG. 5 shows a view of the upper frame 23 and the setup of the upper frame 23 from the side.

The nursing bed 10 is preferably configured such that the foot section 57 can be brought in a vertical position by means of the control device in which the heel of the patient rests on the mattress part 18b (not shown in FIGS. 4a-6) on the foot section 57 and thus the foot section 57 supports at least a portion of the weight of the lower leg of the patient while the lower leg section 47 is arranged in the position for each position of the lower leg section 47 of the range of positions for therapeutic or preventive raised leg placement. In doing so, pressure locations at the lower sides of the lower legs can be avoided that are created if the lower leg rests on the foot side edge 85 (see FIGS. 1,2) of the mattress part 18b arranged on the lower leg section 47.

The control device is preferably configured to adapt a position of the foot section 57 to the position of the lower leg section 47 during the height adjustment of the lower leg section 47 in each position of the range of positions relative to the upper frame 23 for therapeutic and preventive raised leg placement such that the heels of the patient always rest on the mattress part 18b supported by the foot section 57 during the height adjustment of the lower leg section 47 such that the mattress part 18b always supports at least a portion of the weight of the lower legs of the patient due to the heels of the patient resting on the mattress part 18b.

Preferably, the control device of the nursing bed 10 is configured that the distance 87 of the second frame 35 from the lower leg section 47 in the flat lying position of the lying frame 33 is maintained during the movement of the lower leg section 47 in one of the positions of the range of positions for raised leg placement and the adaption of the vertical position of the second frame 35, wherein in this context “maintain” means a change of the distance 87 of at most 10%. Preferably the distance 87 between the lower leg section 47 and the foot section 57 remains even constant.

Preferably the control device of the nursing bed 10 is configured such that the vertical position (height) of the second frame 35 can be adjusted relative to the upper frame 23 whereas the position of the lower leg section 47 relative to the upper frame 23 of the base 20 remains unchanged. By means of the control device, the second frame 35 can be lowered and/or lifted preferably relative to the upper frame 23 while the distance from the lower leg section 47 to the upper frame 23 of the base 20 remains unchanged.

The control device of the nursing bed 10 is preferably configured to be able to lower the foot section 57 relative to the lower leg section 47 in order to relief the heel at least partly if the lower leg section 47 is positioned in a lifted position for raised leg placement and/or if the lower leg section 47 is positioned in the flat lying position. In doing so, the control device is preferably configured such that the position of the lower leg section 47 for raised leg placement is maintained during lowering of the foot section 57. Particularly, preferably the control device is configured for lowering, such that the heal preferably still rests on the mattress part 18b on the foot section 57 in the lowered position such that the foot section 57 supports a portion of the weight of the lower leg of the patient.

Particularly, preferably the control device is configured to lower the second frame 35 relative to the lower leg section 47 for preparing the rotation of the first frame 34 in a seat position and/or during the rotation of the first frame 34 in a seat position in order to allow the rotation in the seat position.

If the first frame 34 of the inventive nursing bed 10 shall take a seat position, as in FIG. 2 (e.g. controlled by the control device), the lower leg section 47 can be moved separately from the second frame 35 in order to pivot the lower leg section 47 over the second frame 35.

FIG. 5 shows the arrangement for the inventive nursing bed 10 of FIG. 4a in a side view. As in FIG. 4a, the first frame 34 is orientated along the longitudinal direction 42 of the bed outer frame 11 of the nursing bed 10. The lying frame 33 is positioned in the flat lying position. The mattress support surface 54 of the lower leg section 47 of the first frame 34 and the mattress support surface 90 of the foot section 57 of the second frame 35 include an angle (here 180°). The mattress support surface 51, 52, 53, 54 of the first frame 34 and the mattress support surface 90 of the second frame 35 are orientated horizontally. The mattress support surface 90 of the second frame 35 forms a contact surface for supporting the mattress.

FIG. 6 shows the nursing bed 10 in a view with an adjusted lower leg section 47 that is positioned in a lifted position relative to the position in FIG. 5 relative to the upper frame 23 for the raised leg placement of the legs of the patient. The second frame 35 is positioned in the lifted position, in which the mattress part 18b (not shown in FIG. 6) that is supported by the second frame 35 is at least partly able to support the feet of the patient. The distance 87 between the lower leg section 47 and the second frame 35 corresponds in the lifted position preferably up to at most 10% to the distance 87 between the lower leg section 47 and the second frame 35 in the flat lying position. Preferably the distance 87 between the lower leg section 47 and the second frame 35 in the lifted position is equal to the distance 87 between the lower leg section 47 and the second frame 35 in the flat lying position. The amount of the angle included by the mattress support surface 54 of the lower leg section 47 and the mattress support surface 90 of the foot section 57 of the second frame 35 corresponds up to at most 10% to the angle in the flat lying position. Preferably the amount of the angle is unchanged.

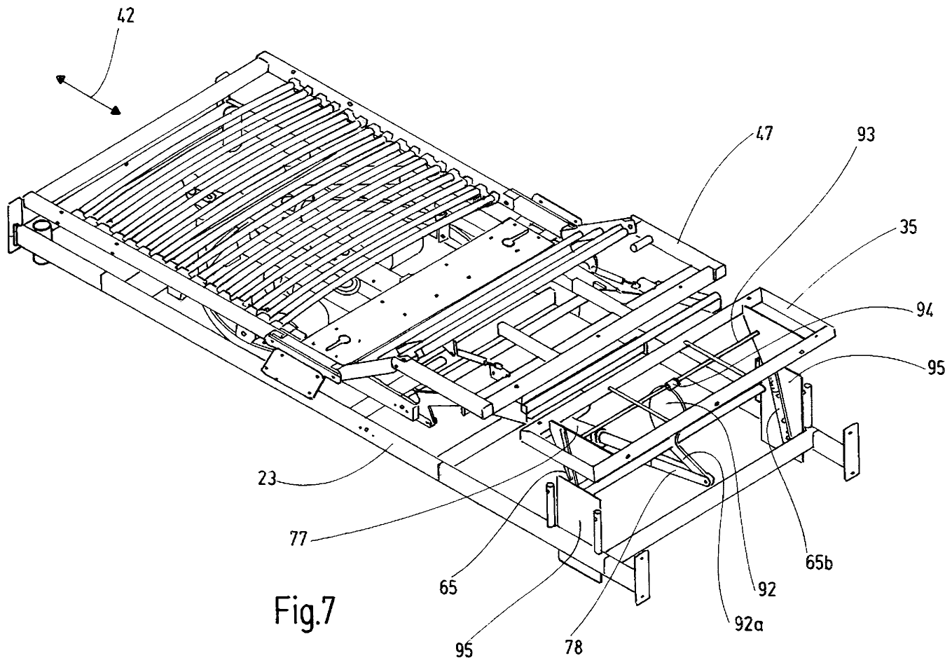

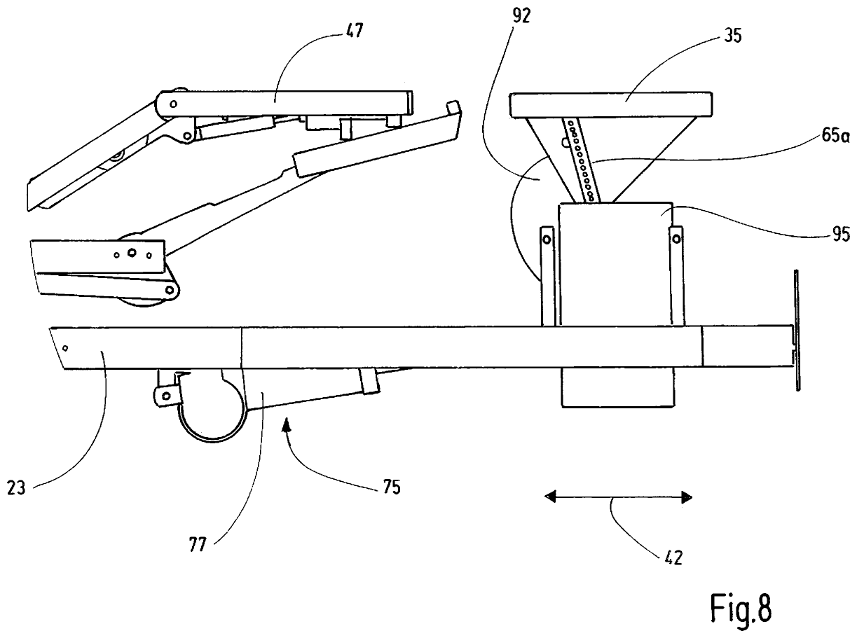

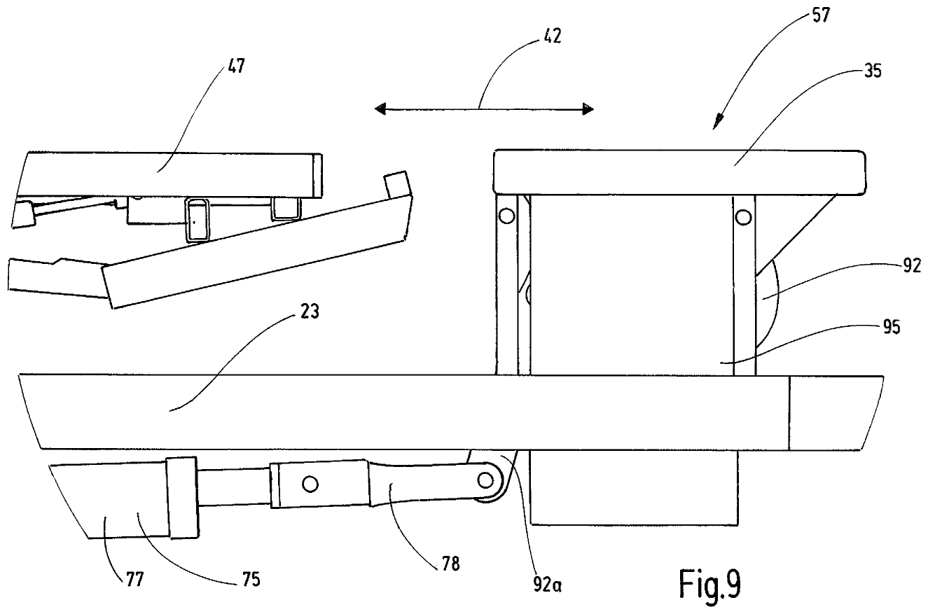

FIG. 7 shows an arrangement for an embodiment of an inventive nursing bed 10 in perspective view, wherein the arrangement can be set up substantially in the same manner as the arrangement for an inventive nursing bed 10 according to FIGS. 4a, 4b to 6. Particularly two telescopic guides 65a, b are arranged below the second frame 35. The control device of this embodiment can provide the same functionality as the control device of the embodiment of the nursing bed 10 according to FIGS. 4a, 4b to 6. FIG. 7 shows a position in which the second frame 35 is lifted in order to adapt the positioning of the second frame 35 to the lifted position of the lower leg section 47. FIG. 8 shows a portion of the inventive embodiment of the arrangement according to FIG. 7 in the same position. FIG. 9 shows a portion of the arrangement according to FIG. 7 with lowered second frame 35 in order to arrange the foot section 57 in a position for the flat lying position of the nursing bed 10.

Different to the embodiment according to FIGS. 4a, 4b to 6, in the embodiment according to FIGS. 7, 8 and 9, however, the positioning movement of the linear drive 75 for the height adjustment is transmitted to the second frame 35 via a cam 92. For this a support element 93 is attached to the second frame 35, on which a cylindrical roller 94 is rotationally supported about a rotation axis that is arranged transverse to the longitudinal direction 42 of the nursing bed. The cam 92 is pivotably supported about a horizontal pivot axis that is transverse to the bed longitudinal direction 42 at opposite parts 95 fixedly attached to the frame. For driving the second frame 35 for height adjustment only one drive 75 can be present, as illustrated. The cam 92 comprises a lever section 92a, the end of which is connected with a moveable second part 78. The other part 77 of the linear drive 75, compared with which the part 78 of the linear drive is moveable, is attached at the upper frame 23. The other part 77 is, e.g. attached below the first frame 34 at the upper frame 23. If the linear drive 75 is controlled for lifting the second frame 35, it pivots the cam 92 via the part 78 of the linear drive 75 connected with the lever section 92a, such that the cam 92 pushes the second frame 35 upward via the roller 94, whereas the roller 94 rolls along the outer edge of the cam 92 (compare FIG. 7). For lowering the second frame 35, the cam 92 is pivoted in the counter direction, wherein the second frame 35 is lowered due to the own weight of the second frame 35 while the roller 94 rolls along the outer edge of the cam 92.

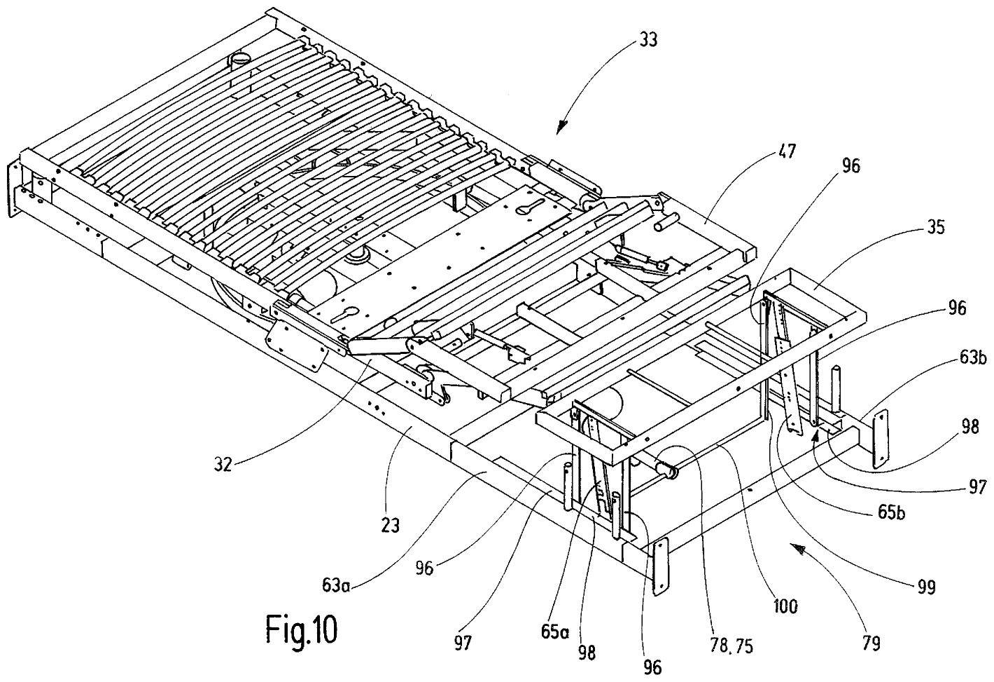

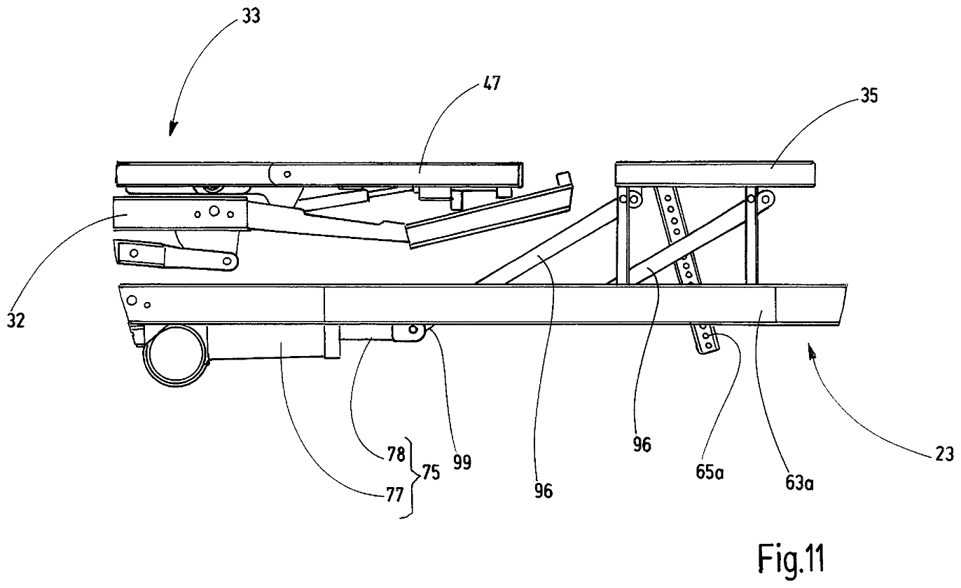

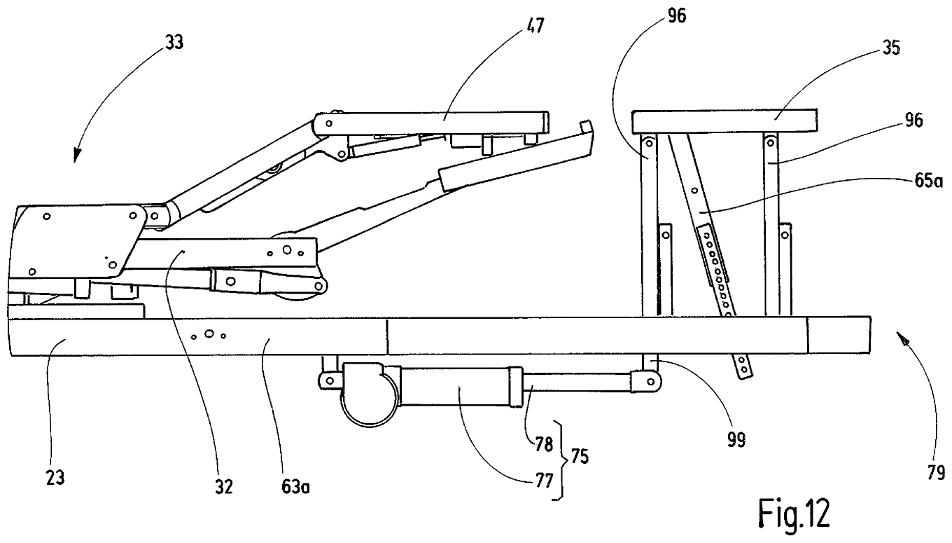

The FIGS. 10, 11 and 12 show a further embodiment of the arrangement with an upper frame 23, intermediate frame 32 and lying frame 33 for an inventive nursing bed 10. Also two telescopic guides 65a, b for guiding the movement of the second frame 35 during the height adjustment are attached at the second frame 35. On opposite sides at the second frame 35 two rods 96 are hinged respectively. The two rods 96 of each side are on the other side also hinged to a slide 97 that is moveably guided in the direction toward the foot end 79 and away from the foot end 79 in a guide rail 98 attached at the upper frame 23. In FIG. 10 the one slide 97 is completely covered by the longitudinal strut 63a of the upper frame 23 and the guide rail 98, in which the slide 97 is guided. The other slide 97 is largely covered by the guide rail 98 at the opposite longitudinal strut 63b of the upper frame 23. At least one rod 96, preferably the rod 96 arranged away from the foot end 79, comprises on each side a section 99 that extends away from the second frame 35 away from the pivot axis that extends through the rod 96. At the end of the section 99 the moveable part 78 of the linear drive 75 for height adjustment of the second frame 35 is particularly attached. In the illustrated embodiment a transverse element 100 between the sections 99 of the opposite rods is attached at the sections 99 for this purpose that is connected with the part 78 of the linear drive. The other part 77 (compare FIGS. 11 and 12) of the linear drive 75, relative to which the moveable part 78 is moveable, is attached at the upper frame 23. FIGS. 11 and 12 show portions of the arrangement according to FIG. 10. If the linear drive 75 is controlled initiating from the position of the second frame 35 illustrated in FIG. 11 for lifting the second frame 35, e.g. by a control device, that provides a functionality as described in the context of the embodiments of the nursing bed 10 according to FIGS. 4a, 4b, 5 and 6, the moveable part 78 of the linear drive 75 is moved in direction toward the foot end 79, wherein the ends of the rods 96 hinged at the slide 97 are pushed in direction toward the foot end 79 via the moveable part 78 and the sections 99 as well as the slide 97, such that the second frame 35 is lifted in a guided manner by the telescopic guides 65a, b via the ends of the rods 96 hinged at the second frame 35. The FIGS. 10 and 12 show the second frame 35 in a completely lifted position.

The telescopic guides 65a, b for guiding the movement of the second frame 35 during lifting and lowering relative to the upper frame 23 do not have to be linear guides. Alternatively, the guides 65a, b can be configured for example for guiding the movement along a arcuate path, e.g. a curve.

The inclination of the mattress support surface 90 of the second frame 35 for the mattress part 18b can be changeable or unchangeable. The mattress support surface 90 of the second frame 35 is preferably horizontal.

According to the invention, a nursing bed 10 is provided that comprises a first frame 34 that supports a first mattress part 18a. The first frame 34 comprises a central section 40, a back section 44 and a thigh section 46 as well as a lower leg section 47. In addition, the nursing bed 10 comprises a second frame 35 with a foot section 57, wherein the second frame 35 supports a second mattress part 18b. The first frame 34 and the second frame 35 of the inventive nursing bed 10 are supported by a base 20 of the nursing bed 10. In the inventive nursing bed the second frame 35 is supported separately from the first frame 34 at the base 20. The inventive nursing bed 10 is particularly characterized in that the second frame 35 that is separately supported from the first frame 34 by the base 20 is height adjustable relative to the base 20. If the vertical position of the second frame 35 relative to the base 20 and/or relative to the central section 40 can be adapted to the position of the lower leg section 47, a nursing bed 10 can be adjusted such that the heals of the patient are supported by the second mattress part 18b on the foot section 57 and are thus supported by the second frame 35, if the lower leg section 47 is arranged in a position for raised leg placement. This leads to a relief for the patient and to an improvement of the raised leg placement for therapeutic and preventive purposes. In one position of the raised leg placement for therapeutic and preventive purposes the lower leg of the elevated supported leg of the patient is higher supported than its pelvis and the foot of the elevated supported leg arranged higher than the pelvis. The inventive nursing bed 10 can be configured for guidance of the second frame 35 for the height adjustment of the second frame 35, such that during a guided movement of the second frame 35 in upward direction relative to the base 20 the distance between the orthogonal projection of the second frame 35 onto a horizontal plane extending through the nursing bed 10 and the head end 70 of the nursing bed 10 measured in horizontal direction is reduced and/or that during a guided movement of the second frame 35 relative to the base 20 in downward direction concurrently the distance between the orthogonal projection of the second frame 35 onto a horizontal plane extending through the nursing bed 10 and the head end 70 of the nursing bed 10 measured in horizontal direction is increased. In doing so, the position of the second frame 35 can be adapted to the position of the lower leg section 47, if the position of the lower leg section 47 for raised leg placement is changed. With a guiding arrangement 65a, b of the nursing bed 10 the second frame 35 can be guided along a straight path inclined to the vertical, e.g. relative to the base 20 during the height adjustment, wherein the path is tilted toward the head end 70 of the nursing bed 10. Alternatively or additionally, the second frame 35 can be guided relative to the base 20 by means of a guiding device of the inventive nursing bed 10 during the height adjustment, e.g. along a path curved toward the head end 70 of the nursing bed 10. Alternatively or additionally, the second frame 35 can be moveable in a guided manner by means of a guide device, e.g. at least one perpendicularly orientated telescopic guide for guide adjustment in perpendicular direction upward and/or downward relative to the base 20, such that the distance between the orthogonal projection of the second frame 35 onto a horizontal plane extending through the nursing bed 10 and the head end 70 of the nursing bed 10 measured in horizontal direction is not changed during the guided movement.

### LIST OF REFERENCE SIGNS

| | |
|---|---|
| 10 | nursing bed |
| 11 | bed outer frame |
| 12 | head part |
| 13 | foot part |
| 14, 15 | side walls |
| 16 | bedstead |
| 17 | support surface |
| 18 | mattress |
| 18a | mattress part |
| 18b | second mattress part |
| 20 | base |
| 21 | lower frame |
| 22 | ground |
| 23 | upper frame |
| 25, 26 | toggle lever pairs |
| 27 | lift motor |
| 31 | height axis |
| 32 | intermediate frame |
| 33 | lying frame |
| 34 | first frame |
| 35 | second frame |
| 40 | central section |
| 41 | longitudinal struts |
| 42 | longitudinal direction |
| 44 | back section |
| 45 | longitudinal struts |
| 46 | thigh section |
| 47 | lower leg section |
| 48 | longitudinal struts |
| 49 | longitudinal struts |
| 50 | transverse strut |
| 51, 52, | mattress support surfaces |
| 53, 54 | (contact surface for |
| | support of the mattress) |
| 57 | foot section |
| 58 | longitudinal sides |
| 59 | swivel joint |
| 60 | second support device |
| 61 | first support device |
| 62a, b, c | transverse struts |
| 63a, b | longitudinal struts |
| 65a, b | telescopic guide |
| 66 | first guide part |
| 67 | second guide part |
| 68 | fastening sections |
| 70 | head end |
| 75 | linear drive |
| 76 | drive unit |
| 77 | first part |
| 78 | second part |
| 79 | foot end |
| 82 | transverse strut |
| 84 | stand |
| 85 | edge |
| 87 | distance |
| 90 | mattress support surface |
| 92 | cam |
| 92a | lever section |
| 93 | support pin |
| 94 | roller |
| 95 | support pin |
| 96 | rods |
| 97 | slide |
| 98 | guide rail |
| 99 | section |
| 100 | transverse element |

1. A nursing bed, comprising:
a base;
a first frame that supports a first mattress part, wherein the first frame comprises a central section, a back section and a thigh section as well as a lower leg section;
a second frame with a foot section, wherein the second frame supports a second mattress part;
wherein the first frame and the second frame are supported by the base;
wherein the second frame is supported separately from the first frame at the base; and
wherein the second frame is height adjustable relative to the base.

2. The nursing bed according to claim 1, wherein the first frame is adjustable, wherein the nursing bed is configured, such that the first frame can be brought into a seat position.

3. The nursing bed according to claim 1, wherein the base is height adjustable.

4. The nursing bed according to claim 1, wherein the nursing bed is configured, such that the second frame is concurrently moved horizontally in direction toward the head end of the nursing bed during the height adjustment.

5. The nursing bed according to claim 1, wherein the nursing bed is configured to adapt the position of the second frame to the position of the lower leg section during a change of the position of the lower leg section.

6. The nursing bed according to claim 1, wherein the nursing bed is configured to maintain the distance of the second frame to the lower leg section of the first frame by a height adjustment of the second frame during a height adjustment of the lower leg section.

7. The nursing bed according to claim 1, wherein the nursing bed is configured to maintain the angle included by the support surface of the lower leg section of the first frame and the support surface of the second frame during the height adjustment of the lower leg section.

8. The nursing bed according to claim 1, wherein the nursing bed is configured to lower the second frame relative to the lower leg section of the first frame.

9. The nursing bed according to claim 1, wherein the nursing bed is configured to lower the second frame relative to the lower leg section of the first frame, if the first frame is in a flat lying position.

10. The nursing bed according to claim 1, wherein the nursing bed is configured to lower the second frame relative to the lower leg section for preparation and/or during an adjustment of the first frame from a lying position in a seat position or from a seat position in a lying position.

11. The nursing bed according to claim 1, wherein the nursing bed comprises a first drive that is assigned to the first frame for adjustment of the first frame and wherein the nursing bed comprises a second drive that is assigned to the second frame for adjustment of the second frame, wherein the first drive and the second drive are drives separate from each other.

12. The nursing bed according to claim 1, wherein between the first frame and the second frame a virtual vertical plane is arranged, wherein the drive for the second frame is arranged on one side of the plane and wherein the first frame is arranged on the other side of the plane.

13. The nursing bed according to claim 1, wherein the first mattress part and the second mattress part are mattress parts separate from each other.

14. The nursing bed according to claim 1, wherein at least two telescopic guides for guiding the second frame during the height adjustment relative to the base and preferably at least one linear drive for driving the second frame for height adjustment are assigned to the second frame.

15. The nursing bed according to claim 2, wherein the base is height adjustable.

16. The nursing bed according to claim 15, wherein the nursing bed is configured, such that the second frame is concurrently moved horizontally in direction toward the head end of the nursing bed during the height adjustment.

17. The nursing bed according to claim 16, wherein the nursing bed is configured to adapt the position of the second frame to the position of the lower leg section during a change of the position of the lower leg section.

18. The nursing bed according to claim 17, wherein the nursing bed is configured to maintain the distance of the second frame to the lower leg section of the first frame by a height adjustment of the second frame during a height adjustment of the lower leg section.

19. The nursing bed according to claim 18, wherein the nursing bed is configured to maintain the angle included by the support surface of the lower leg section of the first frame and the support surface of the second frame during the height adjustment of the lower leg section.

20. The nursing bed according to claim 19, wherein the nursing bed is configured to lower the second frame relative to the lower leg section of the first frame.
